(19) United States
(12) Patent Application Publication
(10) Pub. No.: US 2022/0403809 A1
(43) Pub. Date: Dec. 22, 2022

(54) WAVE ENERGY CONVERTER AND BUOY

(71) Applicant: Ocean Harvesting Technologies AB, Karlskrona (SE)

(72) Inventors: Mikael Sidenmark, Listerby (SE); Ahmed Rashid, Ronneby (SE); Andreas Berg, Västra Frölunda (SE)

(21) Appl. No.: 17/779,098

(22) PCT Filed: Nov. 25, 2020
(86) PCT No.: PCT/SE2020/051129

§ 371 Date: May 23, 2022

(30) Foreign Application Priority Data
Nov. 25, 2019 (SE) 1951347-2
Feb. 12, 2020 (SE) 2050152-4

(51) Int. Cl. F03B 13/18; F16F 9/02; B63B 22/04

(52) U.S. Cl. CPC F03B 13/18; F16F 9/0209; B63B 22/04

(57) ABSTRACT

A buoy, preferably for a wave energy converter system, comprises a central portion; and one or a plurality of buoyancy blocks connected, directly or indirectly, to the central portion. By providing the central portion with a bell mouth opening and attachment means for a wire or rope, a buoy with improved characteristics is provided.

### TECHNICAL FIELD

The present disclosure relates generally to wave energy conversion and more particularly to a power take-off (PTO) device with features to provide PTO force control and energy smoothing. A wave energy converter and a wave energy converter system are also provided.

### BACKGROUND

Different types of wave energy converters (WEC's) have been proposed, in which a power take-off is used for converting linear motion into rotary motion, and for applying a force to the buoy to capture power from the waves, constrain the buoy motion and control the phase of buoy motion relative to the waves.

One challenge with a PTO force necessary to provide the above-mentioned features is that power flows back and forth through the PTO device in every wave cycle. To provide the necessary force control features in the PTO device, i.e., to control the phase of the buoy motion, to balance power capture with loads and losses in order to minimize the cost of energy, to provide a pre-tension force to keep tension in the tether mooring of a point absorbing WEC, and to output approximately 500 kW nearly constant output power, the system needs to manage approximately 5 MW peak power, >30 kWh useful energy storage capacity.

### SUMMARY

An object of at least some implementations of the present disclosure is to provide an improved design of a wave energy converter, with reduced requirements of the power take-off and an improved design of the buoy/prime mover.

According to the disclosure, there is provided a buoy, preferably for a wave energy converter system, comprising a central portion; and one or a plurality of buoyancy blocks connected, directly or indirectly, to the central portion, the buoy being characterized in that the central portion comprises a bell mouth opening and attachment means for a wire or rope.

In an embodiment, the bell mouth is a channel with a gradually increasing diameter towards an open end thereof.

In an embodiment, the open end is facing downward, when the buoy is in operation.

In an embodiment, the attachment means comprises a shackle.

In an embodiment, a bell of the bell mouth opening is encapsulated in a cylinder. The cylinder has preferably enough volume for the central portion to be at least neutrally buoyant.

In an embodiment, the central portion is made of steel.

In an embodiment, a plurality of support portions is provided extending radially from the central portion; wherein the buoyancy blocks are arranged between adjacent support portions.

In an embodiment, each of the support portions comprises an upper support beam with an inner end attached to the central portion, a lower support beam with an inner end attached to the central portion, and an outer support beam with an upper end attached to an outer end of the upper support beam and a lower end attached to an outer end of the lower support beam. The upper support beams and/or the lower support beams are preferably T-shaped beams.

In an embodiment, the buoyancy blocks are arranged between two adjacent support portions comprise one or more inner buoyancy blocks and one or more outer buoyancy blocks. The buoyancy blocks arranged between two adjacent support portions preferably comprise at least two layers of buoyancy blocks, wherein the layers preferably are adhesively joined to each other.

In an embodiment, the buoyancy blocks are made of foam injected plastic shells. Alternatively, the buoyancy blocks are made of drop stitched reinforced inflatable plastic bodies, preferably made of any of the following: PVC tarpaulin, basalt and glass fiber reinforced polypropylene plastic.

According a second aspect of the disclosure, a wave energy converter unit is provided which is characterized by a buoy and a power take-off system attached to the buoy, preferably by means of a wire or rope.

In an embodiment, the wave energy converter unit comprises a mooring rope between the power take-off system and a sea floor foundation, the mooring rope preferably having a spliced loop end in an upper end thereof and a rope termination, preferably with a quick connector, attached to the seabed foundation.

According a third aspect of the disclosure, a power take-off system is provided comprising a power take-off platform and a mooring cylinder adapted to be moored to a seabed, the power take-off system being characterized in that the mooring cylinder comprises a first cylindrical part attached to the power take-off platform and a second cylindrical part telescopically provided in the first cylindrical part provided with bottom part actuated by level roller screw.

In an embodiment, the first cylindrical part is attached directly to the power take-off platform, preferably guided by using linear guide rails attached with the PTH hull.

In an embodiment, the first cylindrical part is provided with an exit at the bottom end thereof for an electric power cable.

According to a fourth aspect of the disclosure, a power take-off system is provided comprising a power take-off hull and a power take-off platform provided in the power take-off hull, and a mooring cylinder adapted to be moored to a sea bed, the power take-off system being characterized by a pre-tension system with a pre-tension gas spring cylinder integrated with the mooring cylinder.

In an embodiment, the pre-tension system is provided with an external gas container, preferably comprising a composite pipe coiled inside the power take-off hull and adapted to contain a gas volume in a single pipe system, preferably a gas volume 5-10 times larger than that of the gas cylinder.

In an embodiment, an elastic hose, preferably a latex or silicone hose, is provided inside the external gas container and adapted to be filled with sea water, preferably by means of a pump, to reduce the gas volume of the external gas container.

In an embodiment, an additional external gas container, preferably a second coiled pipe, is provided connected to the external gas container by means of an air compressor.

In an embodiment, at least one of the external gas containers and the additional external gas container is provided with valves, preferably ball valves, arranged between different sections of the container.

In an embodiment, a gas compressor is provided with pipe connections on either side of a valve provided in the external gas container.

In an embodiment, the pre-tension gas spring cylinder has a bottom end stop buffer, preferably comprising a gas port to a compression chamber of the cylinder being located at a distance from the bottom of the pre-tension gas cylinder, preferably 0.5 meter distance.

In an embodiment, a piston of the pre-tension gas spring cylinder is coned at the bottom of the piston.

In an embodiment, the pre-tension gas spring cylinder has a top end stop buffer, preferably a ring inside the pre-tension gas spring cylinder and the top of a gas spring piston being shaped to fit inside a top ring of pre-tension gas cylinder, preferably with channels in the intersection between the top ring and the pre-tension gas cylinder, that gradually close the passage of gas from the gas cylinder chamber to the power take-off hull.

### BRIEF DESCRIPTION OF THE DRAWINGS

The disclosure is now described, by way of example, with reference to the accompanying drawings, in which:

FIG. 1 shows a complete single WEC unit with buoy, PTO and sea floor foundation.

FIG. 2a shows a cross-sectional view of a sectionized buoy, with a bell mouth for a mooring rope in the center and steel frame walls to distribute load between foam filled buoyancy blocks.

FIG. 2b shows one section of a buoy shown in FIG. 2a with one wall frame and four buoyancy elements for one section of the buoy.

FIG. 2c shows view of a buoy with 6 sections and three layers, with one section removed, to show the steel support wall structure between the sections.

FIG. 2d shows a view of a buoy with a single section of buoyancy material and support structure on top.

FIG. 2e shows a view of a buoy with a single section of buoyancy material and a circular support plate on top with small diameter relative to the buoy diameter.

FIG. 3a shows a schematic of the cross section of a buoy and bell mouth.

FIG. 3b shows a schematic of the cross section of a tilted buoy and bell mouth.

FIG. 4 is a cross-sectional view of the PTO system of FIG. 1 including level telescope and pre-tension gas spring system.

FIG. 5a is a cross-sectional view of the PTO hull and PTO platform of FIG. 1.

FIG. 5b shows a PTO assembly with ball screw actuators and a PTO platform.

FIG. 6a shows a cross-sectional view of a pre-tension gas spring system with top and bottom end stop buffers and a first part of an external gas container composite pipe.

FIG. 6b is a schematic view of a gas spring depressurization system and control of an external gas volume.

FIG. 7 is a cross-sectional view of a telescopic level adjustment system and an exit for an export cable.

FIG. 8 shows a mooring rope and gravity-based sea floor foundation based on ballasted steel cage.

FIG. 9a shows a cluster with 20 WEC units, a spar buoy substation and export cables connected from each WEC unit to the substation.

FIG. 9b is an enlarged view of the spar buoy substation of FIG. 8a with two heave plates and weight to cancel movements and with four-point catenary mooring for station keeping.

FIG. 10 shows the schematics of an electrical system to connect 20 WEC units to a central substation.

### DETAILED DESCRIPTION

In the following, a Wave Energy Converter (WEC) system, comprising an improved design of the buoy structure and power take-off (PTO) system with integrated pre-tension and level adjustment, will be described in detail.

When references are made to directions, such as “up” or “top”, these refer to the directions shown in the figures, i.e. after installation of the WEC unit at sea.

The PTO force is divided in one passive constant part provided by a pre-tension spring, and an active controllable part provided by ball screw actuators with direct drive torque motors using torque control, which can instantly provide any direction and amplitude of the torque within the design ratings as requested by the control system.

Optimal power capture with non-predictive or predictive control strategy can be achieved together with external pre-tension, with the objective to optimize the export power, considering the PTO efficiency and constraints, such as maximum stroke length, velocity and tether force. The resulting tether force and power with and without external pretension are nearly the same, when an efficiency- and constraint-aware control is applied. The only difference between both tether force and power curves are due to the fact that without external pretension the average mooring tension changes for each wave or set of consecutive waves, while with external pretension the average mooring tension is constant all the time or it is slowly-tuned for each state. Due to the efficiency- and constraint-awareness of the controller and the utilization of external pretension system, which can provide the necessary reverse power for tensioning the tether, the PTO/ball screw force can be tuned in a way that no power flow occurs in the reverse direction, i.e. from an electric energy storage unit through the motors to the tether. This way the electrical energy storage is decoupled from the force control and only used for smoothing of the output power. The energy losses are reduced due to the fact that reciprocating power flows are avoided through the main drive-train components, which have lower overall efficiency than the passive pneumatic pretension spring system.

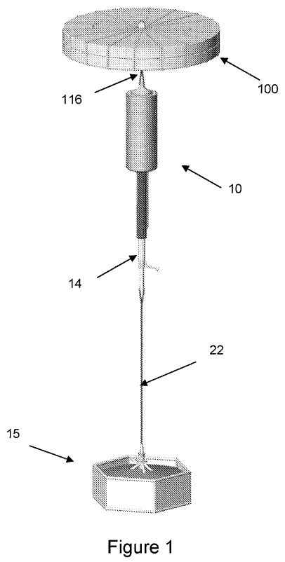

FIG. 1 shows a complete wave energy converter (WEC) unit 1 with a buoy 100 attached to a PTO hull 10 of a PTO system, preferably by means of a link rope 12, providing tensile stiffness and bending flexibility. A mooring rope 14 connects the bottom end of the PTO system to a gravity-based seabed foundation 16.

The buoy 100 can also be attached to the PTO hull directly with a universal joint.

The purpose of separating the buoy 100 from the PTO hull 10 is to eliminate horizontal forces on the mooring cylinder due to bending moments from the waves interacting with the buoy, enabling this to be much smaller in diameter and lower in cost.

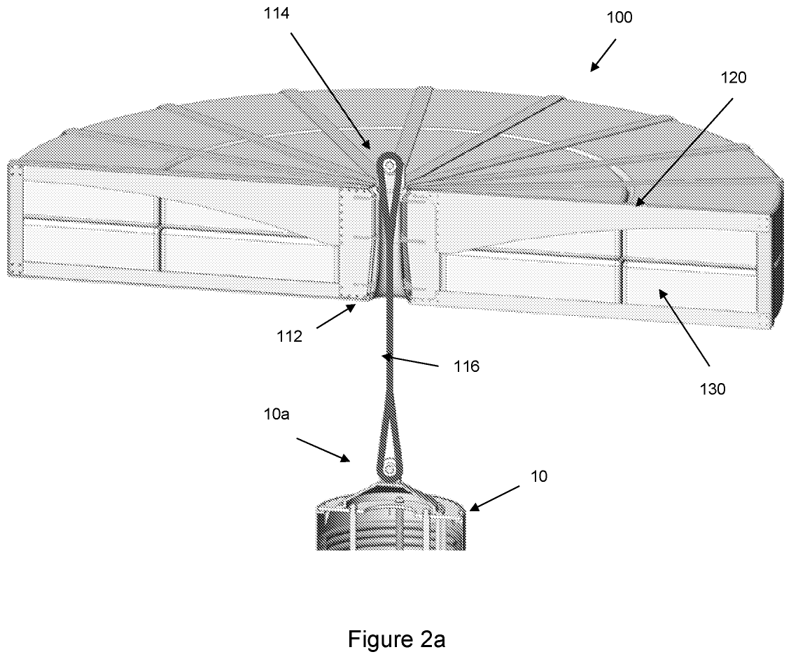

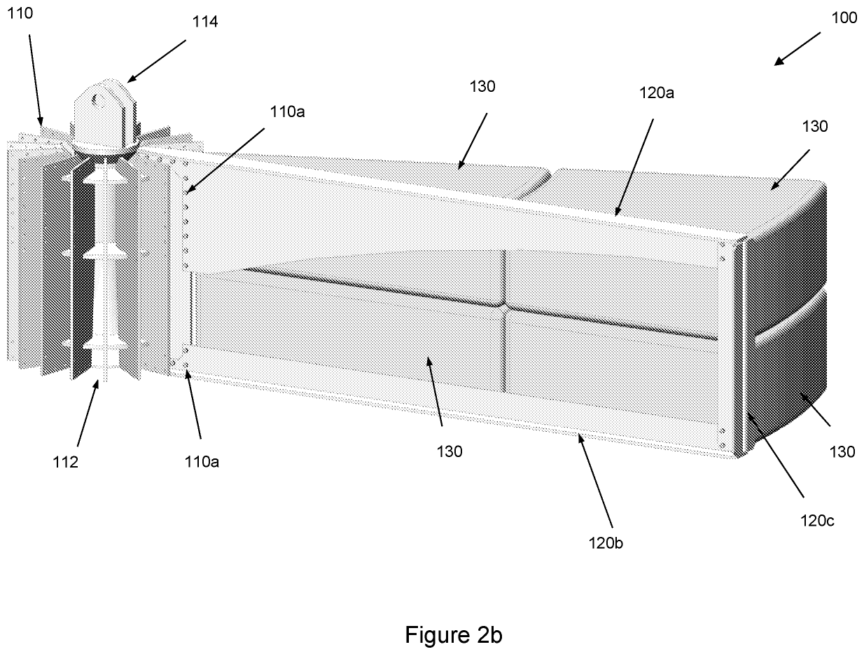

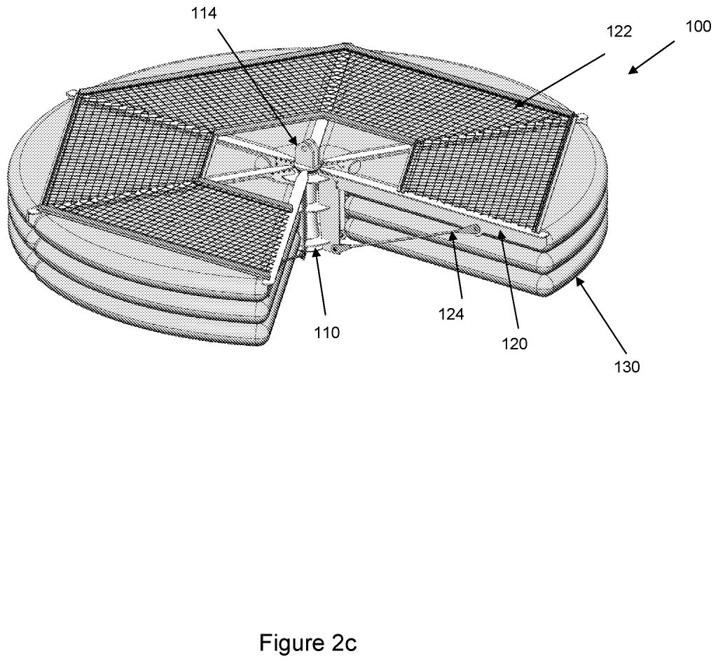

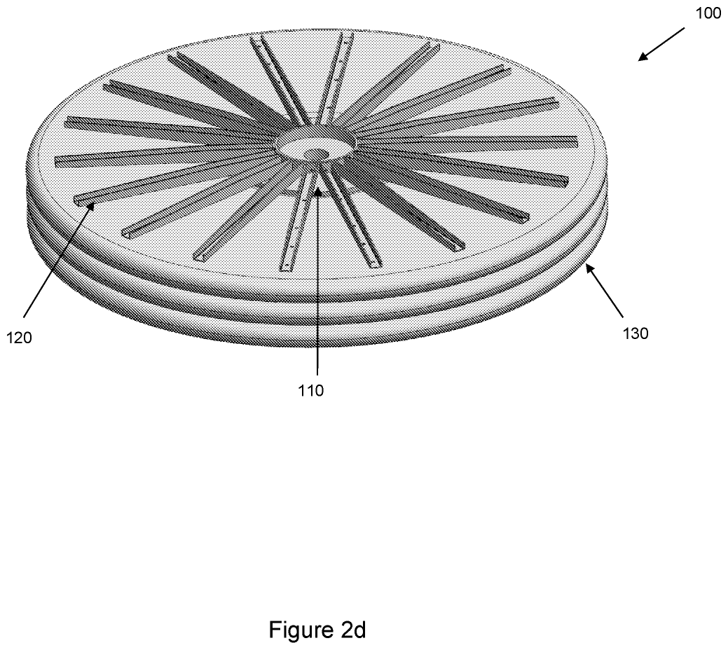

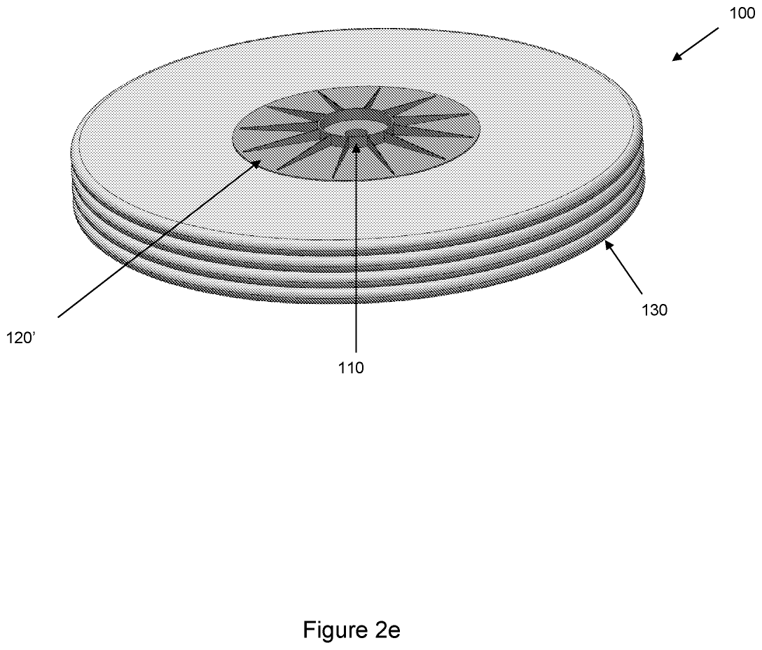

FIG. 2a shows a cross section of the buoy 100, comprising at the center thereof a central portion 110 with a bell mouth 112 with a shackle 114 for a spliced loop end 116a of the link rope 116 on top. More specifically, the bell mouth 112 is a channel with a gradually increasing diameter towards the open end 112a thereof. The open end the is facing downward, when the buoy is in operation is Support portions 120 in the form of steel frames extending radially from the center 110 of the buoy and buoyancy blocks 130 are arranged between the steel frame support portions. The buoyancy blocks 130 are thus connected directly or indirectly to the center portion 110.

The purpose of the bell mouth 112 below the shackle for the link rope is to eliminate movements at the point of the shackle from the rolling motion in the waves, and wear from the same. The PTO hull 10 can also be transported separately from the buoy 100, and installed prior to the buoy, to simplify the installation procedures of the WEC unit and also make it possible to store the equipment more efficiently on an installation vessel.

During installation, a guide rope (not shown) is attached to the top end of the link-rope 116 and pulled through the bell mouth 112 before the buoy is deployed in the water. Once the buoy is placed in the water, the link rope is pulled up through the bell mouth and easily secured by inserting the sprint in the shackle from above.

FIG. 2b shows one section of the buoy 100 comprising four buoyance blocks 130, such as foam injected plastic shells or drop stitched inflatable dock pieces, and a support frame 120 attached to the bell mouth structure by means of bolts 110a. The shell material for the buoyancy blocks 130 can be made from reinforced, preferably basalt or glass fiber, polypropylene or PVC tarpaulin or similar. The steel support frame 120 comprises an upper support beam 120 with the purpose to spread the load applied through the link rope across all buoyancy blocks, and lower 120b and outer support beams 120c to hold the buoyancy blocks 130 in place. In other words, each of the support portions comprises an upper support beam with an inner end attached to the central portion, a lower support beam with an inner end attached to the central portion, and an outer support beam with an upper end attached to an outer end of the upper support beam and a lower end attached to an outer end of the lower support beam.

In the shown embodiment, there are two different shapes of the buoyancy blocks 130, the first being arranged in an inner circle around the bell mouth, and the second being arranged in an outer circle around the bell mouth. In this way, the buoyancy blocks 130 can be manufactured in high volume for low cost. The inner and outer buoyancy blocks are arranged in two layers: an upper layer and a lower layer.

FIG. 2c is similar to FIG. 2b but with wider sections, in this embodiment six sections, and a steel net 122 on top between the support beams 120 to spread the tether force more evenly across the surface of the buoyancy blocks. The support walls 120 are also lighter by means of stays 124. These support stays 124 extend at an angle from the central bell mouth support structure 110 and a respective support wall.

In this embodiment, the buoyancy blocks 130 are in the form of inflatable drop stitch fabric. Drop stitch fabric is a technique for constructing flat, inflatable products. Basically, two pieces of polyester woven support fabric are joined with thousands of fine polyester thread lengths. This base material is usually made in strips from five to ten feet in width, and up to 400 needle heads may be used in the setup. FIG. 2c shows an embodiment with a plurality of layers of buoyancy blocks 130 and more specifically three layers. These layers are preferably glued or laminated together. Drop stitch fabric can be rolled or folded into a compact size when not inflated and are very light, making transportation very easy.

FIG. 2d shows an embodiment of the buoy comprising three layers of buoyancy blocks 130 in the form of ring-shaped drop stitch fabric. Steel support beams 120 spread the load from the central bell mouth support structure across the top surface of the upper buoyancy block. The bell is encapsulated in a cylinder 110, preferably with enough volume for the steel structure to be at least neutrally buoyant. This embodiment requires less labor work for assembly compared to the embodiment shown in FIG. 2c. The drop stitch structure is first partly inflated, the steel cylinder 110 with the bell, i.e., the central bell support structure, is then lowered down into the centre, after which the drop stitch structure is fully inflated, whereby the centre hole through the drop stitch structure shrinks around the steel cylinder to secure the buoyancy blocks. The steel support beams 120 are then bolted to the top of the steel cylinder, after which the buoy 100 is fully assembled and ready for deployment in the sea.

FIG. 2e is similar to FIG. 2d with the support beams replaced with a round steel plate 120′, with smaller diameter than the buoyancy blocks. The diameter is dimensioned to provide sufficient area to transfer the force from the tether mooring across the top of the inflated structure without collapsing the top layer. In this embodiment an extra layer of drop stitch fabric, i.e., an additional buoyancy block 130, is used to increase the stiffness of the structure.

It should be realized that the number of layers used in the inflated structures in FIG. 2c-e can vary depending on the type of steel support structure used and the required stiffness of the inflated structure. Layers are adhesively joined, such as glued together to increase the stiffness, which in turn reduces the required strength of the steel structure and thereby the weight. It will be realized that the embodiments of FIGS. 2c-e also may comprise a single buoyancy block.

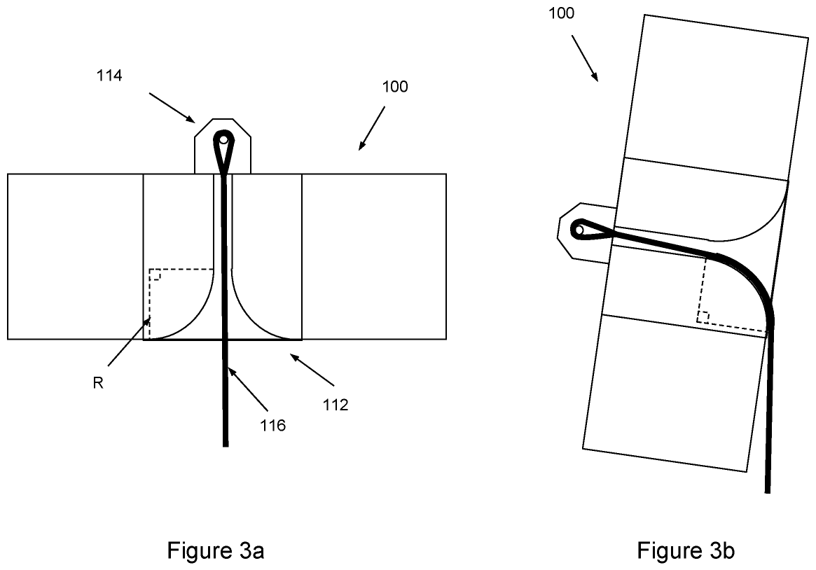

FIG. 3a shows a schematic view of the bell mouth 112 in the buoy 100, having a shackle 114 for the link rope 116 on top, a vertical pipe 118 wide enough to fit the rope loop end 116a, then the bell mouth 112 which widens, preferably with a 90° bend radius R, to the bottom of the buoy 100, allowing the rope 116 to roll inside the bell when the buoy tilts.

FIG. 3b shows a schematic view according to FIG. 3a, with a tilted buoy.

It should be realized that different types of mooring ropes, wires or flexible pipes with different types of connections on the top of the buoy, such as shackles, flange mounts, quick connectors, can be used to link the buoy with the PTO system.

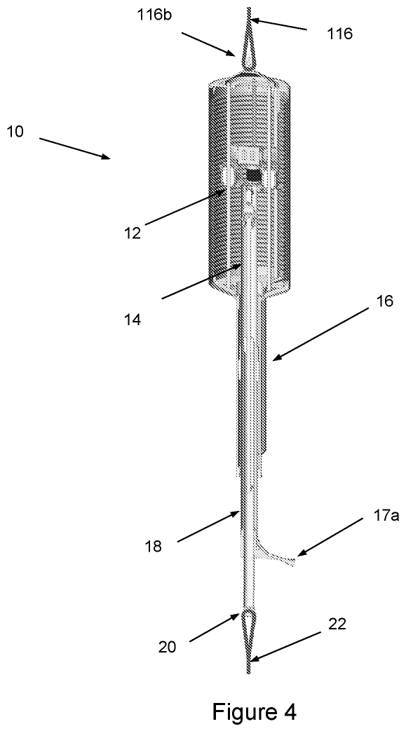

FIG. 4 shows a cross-section of the Power Take Off (PTO) system, comprising four non-rotating ball screws attached to the PTO hull 10, and a PTO platform 12 with ball nuts, torque motors and power electronics located inside the PTO hull and attached on top of mooring device in the form of a mooring cylinder 14. A pneumatic pre-tension spring system and a telescopic level adjustment system is integrated with the mooring cylinder. An exit 18a for a power cable is located near the bottom of a first, upper cylindrical part 18 of the telescopic mooring cylinder. A shackle 20 for a spliced loop end 22a of a mooring rope 22 is located at the bottom of a second, lower cylindrical part 18 of the mooring cylinder.

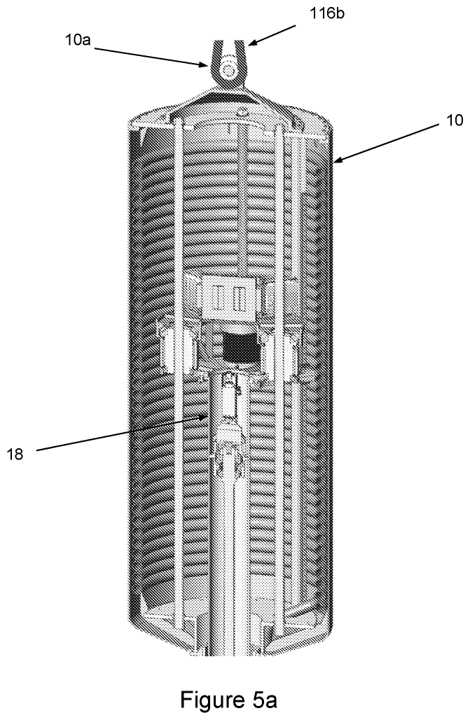

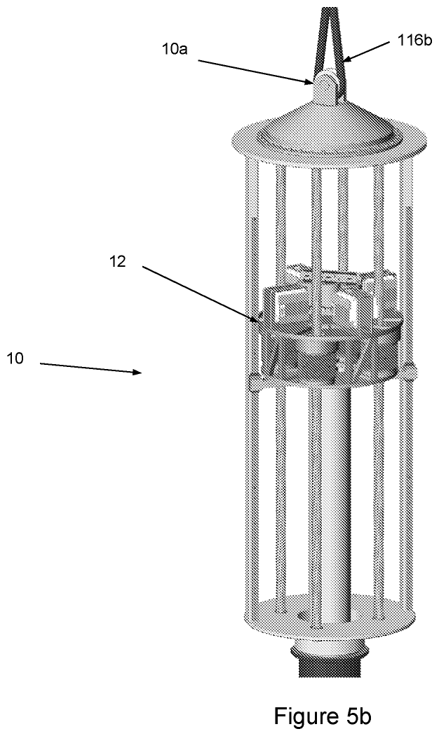

FIG. 5a shows a detailed cross-sectional view of the PTO hull and PTO platform. Four ball screws and two linear guide rails are attached between a top ball screw plate and a bottom ball screw plate of the PTO Hull. The PTO platform in the center of the PTO hull comprises rotating ball nuts engaging a respective of the four ball screws and each having a direct drive torque motor. The PTO platform also comprises AC/DC motor drives, a transformer to step up the voltage before the export cable, and linear guide wagons. The linear guides are necessary to take up the radial forces, since ball screws can only handle axial forces. The transformer is used to reduce the current generated by the PTO system, to reduce the weight and cost of the dynamic power cable.

Inside the top of the first, upper cylindrical part of the mooring cylinder, attached to the PTO platform from below, a level motor and a gearbox are located and connected to the top of a roller screw with thrust bearings, which are used to adjust the extension of the mooring cylinder telescope.

A pipe, such as a composite pipe, is coiled on the inside of the PTO hull, and used as external gas container for a pneumatic pre-tension gas spring system.

FIG. 4b shows a perspective view of the PTO system according to FIG. 4a without the PTO hull and composite gas pipe.

FIG. 5a shows a cross-section of the pneumatic pre-tension system 16, comprising a pneumatic cylinder 16a suspended below the PTO hull 10, a piston 16b attached to the first, upper cylindrical part of the mooring cylinder, a top end stop buffer 16c and a bottom end stop buffer 16d, and a gas port 16e for the gas pipe. The gas port is preferably located approximately 0.5 meter above the bottom of the gas spring cylinder, and the bottom of the piston is preferably coned, whereby the pressure will gradually increase when the piston passes the gas port in order to increase the force and thereby softly stop further telescopic movement of the first and second cylindrical parts 17, 18, i.e. to stop the extension of the PTO system. This buffer force is designed to fully submerge the buoy, without the use of any force through the ball screw actuators, when the wave moves the buoy higher than the available stroke length. The gas port connects to the pressurized chamber of the pneumatic cylinder. The ambient gas chamber of the cylinder is opening at the top into the PTO hull. A ring is added to the top of the cylinder, and the diameter of the top of the piston is reduced to fit inside the top ring of the cylinder. Furrows are made in the ring that are designed to gradually reduce the opening between the PTH hull and ambient chamber of the cylinder when the piston moves up into the ring, whereby the pressure drop across the opening increases to add a damping function, and the pressure in the ambient chamber increases to add a spring function, to the end stop buffer to provide a soft stop without bouncing effects.

The purpose of the pre-tension gas spring system 16 is to divide the total PTO force into one passive part and one active part, to thereby reduce the maximum force and power required by the active part comprising ball screws, torque motors and power electronics, which reduces the cost.

The purpose is also to handle end stops with dampened spring buffers instead of using active force through the ball screws, to improve the safety and reliability of the system.

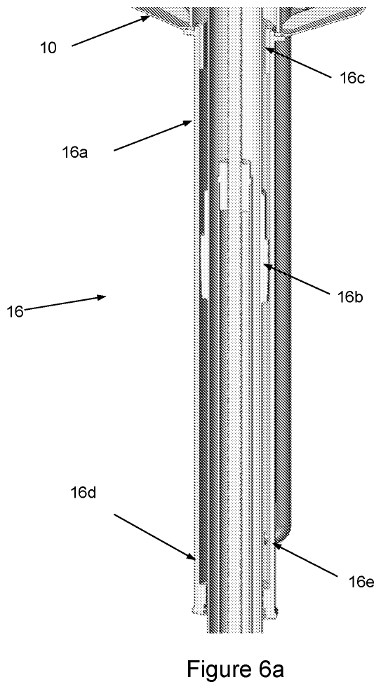

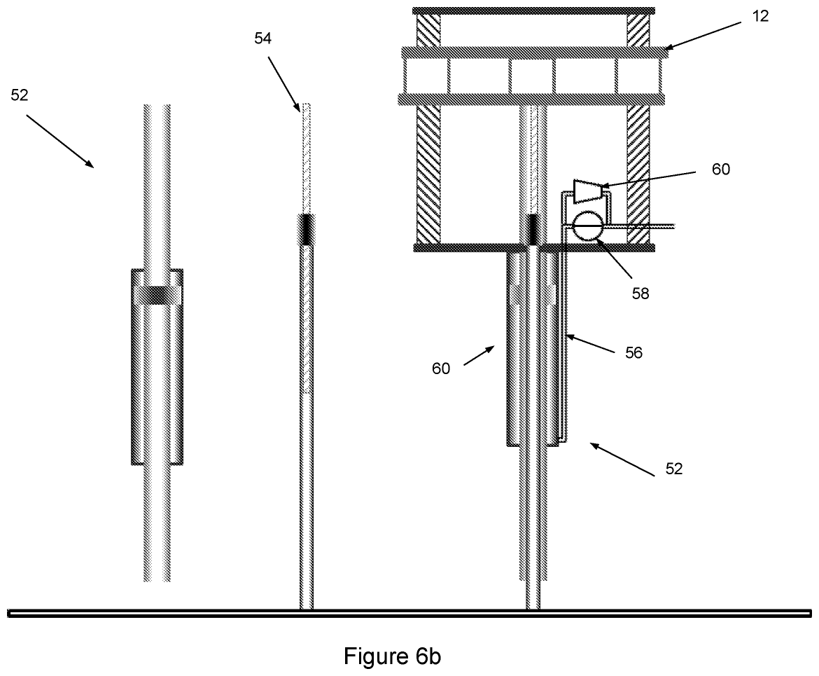

FIG. 6b shows schematic views of the integrated pneumatic pre-tension system and level system, comprising an air cylinder with double sided hollow piston rod 52 with a roller screw 54 inside. The roller screw nut is attached to a second rod, providing a telescopic function for the level system.

A gas pipe 56 is connected at the bottom of the air cylinder to form an external gas container. A close off valve 58 on the gas pipe, with an air compressor 60 connected to the pipe in parallel with the close off valve, is used to disable the pre-tension spring with the piston locked with cylinder fully extended during installation and retrieval. The valve 58 is first closed, then air is pumped from the compression chamber until the piston reaches the gas port.

Using an external gas container such as a composite pipe shown in this embodiment is helpful to create a relatively constant spring force. The volume ratio between the gas cylinder and primary external gas container is preferably in the range from 5:1 to 10:1.

In the case of operating with the buoy fully submerged, it may be useful to modify the gas volume of the external gas container, preferably by adding an elastic hose, preferably latex or silicon, inside the composite pipe which is filled with sea water by means of a pump to reduce the gas volume.

The spring force can furthermore be modified by adding a secondary external gas container 60, preferably a second coiled pipe, connected to the primary external gas container by means of an air compressor. Due to losses in the gas spring, it is desirable to reduce the pre-tension spring force in lower sea states to reduce losses and thereby increase the output of energy.

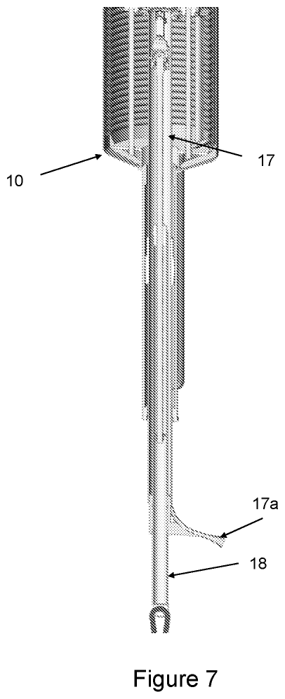

FIG. 7 shows a cross-section of the telescopic mooring cylinder and level adjustment system. The first, upper cylindrical part 17 of the mooring cylinder is attached below the PTO platform, with a motor and gearbox attached to the top of a roller screw, which is mounted to the inside of the mooring cylinder by means of a thrust bearing. A roller screw nut is located at the top of the second, lower part of the mooring cylinder. When the roller screw is rotated, the first and second cylindrical parts 17, 18 of the mooring cylinder are telescopically extended in relation to each other. The upper part 17 of the mooring cylinder is supported by linear bearing and seal at the bottom of the pneumatic gas cylinder, and the bottom part of the mooring cylinder is supported by another set of linear bearing and seal at the lower portion of the first part of the mooring cylinder.

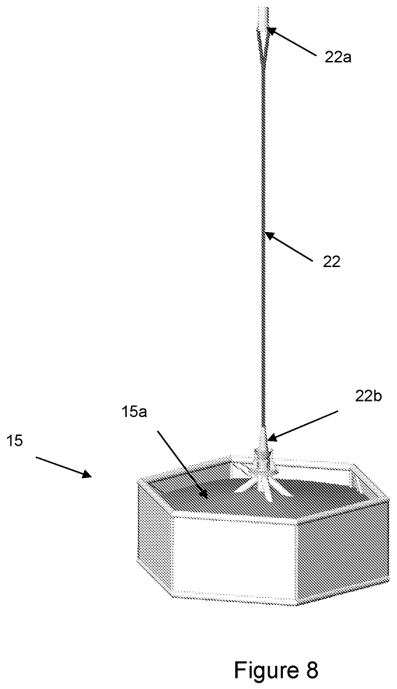

FIG. 8 shows a perspective view of the mooring rope 22 attached to the bottom of the mooring cylinder and to a gravity-based seabed foundation 15. The gravity-based seabed foundation 15 holds a ballast material 15a, preferably high-density gravel made from ferrite in a steel cage. The bottom end 22b of the mooring rope ends in a rope termination and quick connector to the seabed foundation.

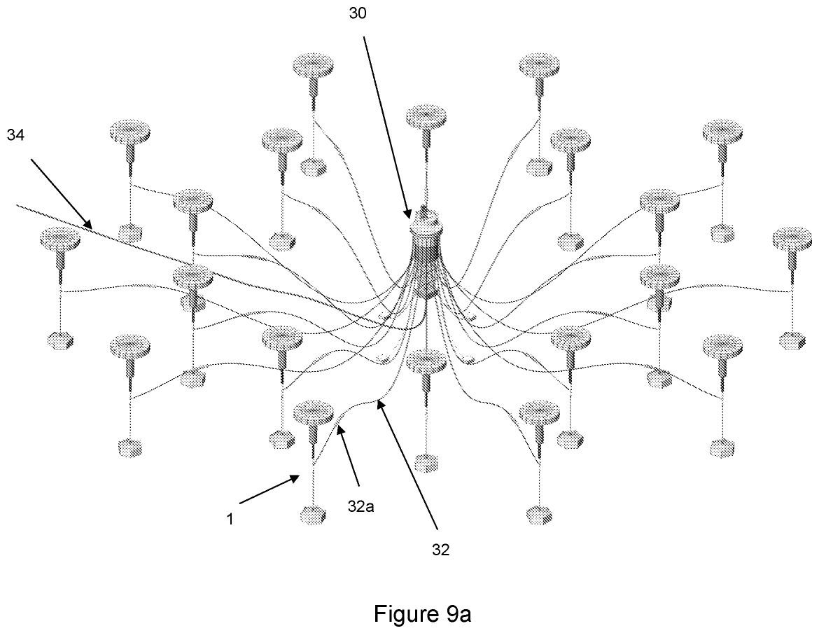

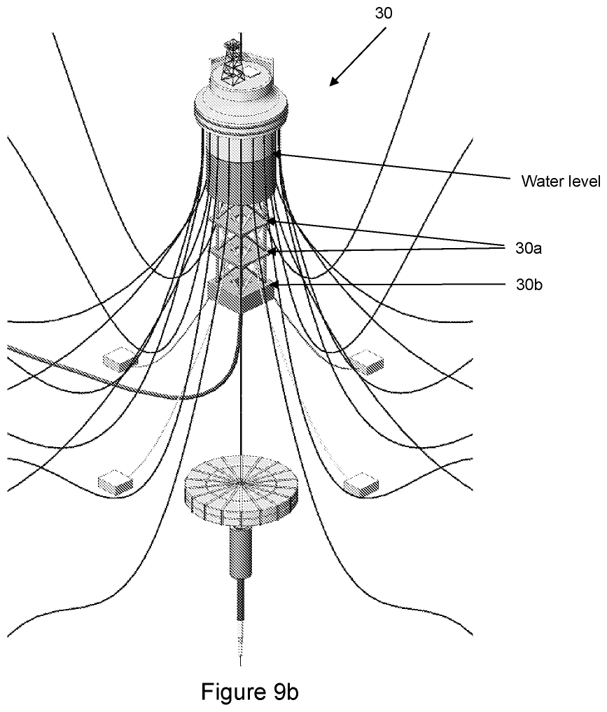

FIG. 9a shows a cluster with 20 WEC units 1 attached to a central spar buoy substation 30 by means of dynamic power cables 32. Each power cable 32 is connected to the electrical system on the PTO platform, and then lead down together with the gas pipe and exits with a bending restrictor. The part of the cable which is in the water is designed for dynamic movements, and buoyancy blocks 32a are used to prevent the cables from touching the seabed. The other end of the cable is connected to the central substation above water, with dry mate connectors. Each substation furthermore has an export cable 34 for the collected power. A wave farm preferably comprises multiple clusters, each connected to a central point for the land cable.

FIG. 9b shows an enlarged view of the spar buoy substation 30, with water level indicated and four catenary moorings and mooring blocks for station keeping. The spar buoy uses two heave plates 30a and a weight 30b at the bottom to remain steady against the wave motion.

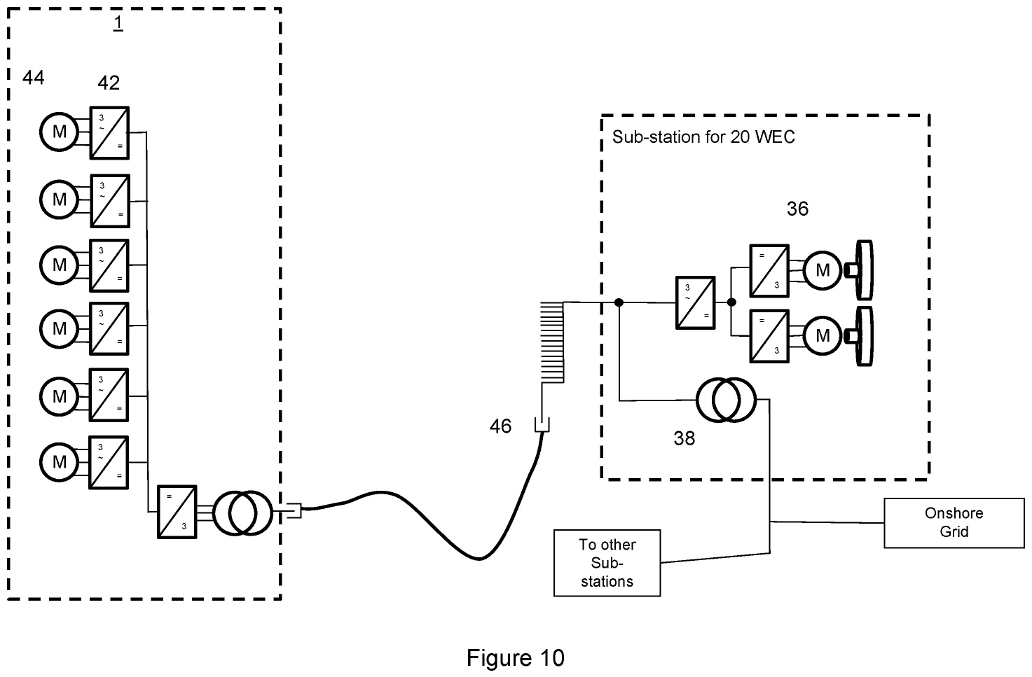

FIG. 10 shows a schematics of the electrical system including 3-phase inverters 42 for each direct drive torque motor 44 in the PTO system of each WEC, the inverter and transformer before the dry-mate connector and export cable, the dry-mate connectors 46 for 20 WEC's in the spar buoy substation 30, and also flywheel energy storage 36 and a second step-up transformer 38 for the interconnection of multiple clusters and/or power cable to the onshore connection point.

It should be noted that other types of energy storage devices, power electronics and structure for the substation can be used without altering the purpose of the disclosure.

A wave energy converter and cluster to connect 10 such units have been described. It will be realized that these can be varied within the scope of the appended claims.

A buoyancy block structure with four buoyancy blocks between adjacent support structures: inner/outer and upper/lower blocks, has been described and shown. It will be appreciated that this structure may be modified without departing from the idea. For example, three or more layers may be provided or just a single layer of blocks. Also, a single buoyancy block may extend from the central portion, i.e., the bell mouth, or three or more blocks may be provided in each layer of buoyancy blocks. The structure of buoyancy blocks determines the size of each of the blocks and depending on the overall size of the buoy, preferably at least 40 meters, different structures may be preferred.

A bell mouth with a shackle has been shown and described. It will be realized that this feature can be implemented in other designs than the one defined by the appended claims. For example, a conventional buoy with a buoy hull made of steel can be provided with the same bell mouth in the center. And the buoy hull without bell mouth can be provided and connected to the PTO hull directly with a universal joint.

A power take-off comprising four ball screw actuators have been shown and described. It will be realized that the PTO system can be implemented with a different number of ball screws than the number defined by the appended claims. For example, any number between two and six can be used.

Certain embodiments or components or features of components have been noted herein as being “preferred” and such indications are to be understood as relating to a preference of the applicant at the time this application was filed. Such embodiments, components or features noted as being “preferred” are optional and are not required for implementation of the inventions disclosed herein unless otherwise indicated as being required, or specifically included within the claims that follow.

1. A buoy for a wave energy converter system, comprising
a central portion;
one or a plurality of buoyancy blocks connected, directly or indirectly, to the central portion, wherein
the central portion comprises a bell mouth opening and attachment means for a wire or rope.

2. The buoy according to claim 1, wherein the bell mouth is a channel with a gradually increasing diameter towards an open end thereof.

3. The buoy according to claim 2, wherein the open end is facing downward, when the buoy is in operation.

4. The buoy according to claim 1, wherein the attachment means comprises a shackle.

5. The buoy according to claim 1, wherein a bell of the bell mouth opening is encapsulated in a cylinder.

6. The buoy according to claim 5, wherein the cylinder has enough volume for the central portion to be at least neutrally buoyant.

7. The buoy according to claim 1, wherein the central portion is made of steel.

8. The buoy according to claim 1, comprising a plurality of support portions extending radially from the central portion;
wherein the buoyancy blocks are arranged between adjacent support portions.

9. The buoy according to claim 8, wherein each of the support portions comprises an upper support beam with an inner end attached to the central portion, a lower support beam with an inner end attached to the central portion, and an outer support beam with an upper end attached to an outer end of the upper support beam and a lower end attached to an outer end of the lower support beam.

10. The buoy according to claim 9, wherein the upper support beams and/or the lower support beams are T-shaped beams.

11. The buoy according to claim 8, wherein the buoyancy blocks arranged between two adjacent support portions comprise one or more inner buoyancy blocks and one or more outer buoyancy blocks.

12. The buoy according to claim 8, wherein the buoyancy blocks arranged between two adjacent support portions comprise at least two layers of buoyancy blocks, wherein the layers preferably are adhesively joined to each other.

13. The buoy according to claim 1, wherein the buoyancy blocks are made of foam injected plastic shells.

14. The buoy according to claim 1, wherein the buoyancy blocks are made of drop stitched reinforced inflatable plastic bodies, preferably made of any of the following: PVC tarpaulin, basalt and glass fiber reinforced polypropylene plastic.

15. A wave energy converter unit, comprising
a buoy according to claim 1 and a power take-off system attached to the buoy.

16. The wave energy converter unit according to claim 15, comprising a mooring rope between the power take-off system and a sea floor foundation the mooring rope preferably having a spliced loop end in an upper end thereof and a rope termination attached to the seabed foundation.

17. A power take-off system comprising a power take-off platform and a mooring cylinder adapted to be moored to a seabed, wherein
the mooring cylinder comprises a first cylindrical part attached to the power take-off platform and a second cylindrical part telescopically provided in the first cylindrical part provided with bottom part actuated by level roller screw.

18. The power take-off system according to claim 17, wherein the first cylindrical part is attached directly to the power take-off platform.

19. The power take-off system according to claim 17, wherein the first cylindrical part is provided with an exit at the bottom end thereof for an electric power cable.

20. A power take-off system comprising a power take-off hull and a power take-off platform provided in the power take-off hull, and a mooring cylinder adapted to be moored to a sea bed, and
a pre-tension system with a pre-tension gas spring cylinder integrated with the mooring cylinder.

21. The power take-off system according to claim 20, wherein the pre-tension system is provided with an external gas container.

22. The power take-off system according to claim 21, comprising an elastic hose inside the external gas container and adapted to be filled with sea water.

23. The power take-off system according to claim 21, comprising an additional external gas container connected to the external gas container by means of an air compressor.

24. The power take-off system according to claim 21, wherein at least one of the external gas containers and the additional external gas container is provided with valves, preferably ball valves, arranged between different sections of the container.

25. The power take-off system according to claim 21 comprising a gas compressor with pipe connections on either side of a valve provided in the external gas container.

26. The power take-off system according to claim 20, wherein the pre-tension gas spring cylinder has a bottom end stop buffer.

27. The power take-off system according to claim 20, wherein a piston of the pre-tension gas spring cylinder is coned at the bottom of the piston.

28. The power take-off system according to claim 20, wherein the pre-tension gas spring cylinder has a top end stop buffer that gradually close the passage of gas from the gas cylinder chamber to the power take-off hull.
